(19) United States
(12) Patent Application Publication
(10) Pub. No.: US 2013/0304637 A1
(43) Pub. Date: Nov. 14, 2013

(54) FRAUD CONTROL INTEGRATED FORM FILLING TOOL

(71) Applicant: American Express Travel Related Services Company, Inc., New York, NY (US)

(72) Inventors: Colin T. McCabe, Brooklyn, NY (US); Francisco Mogollon, Scottsdale, AZ (US)

(21) Appl. No.: 13/945,411

(22) Filed: Jul. 18, 2013

Related U.S. Application Data
(63) Continuation-in-part of application No. 11/866,009, filed on Oct. 2, 2007, now Pat. No. 8,515,840.
Application No. 11/866,009 is a continuation-in-part of application No. 13/708,422, filed on Dec. 7, 2012.
Application No. 13/708,422 is a continuation-in-part of application No. 13/604,976, filed on Sep. 6, 2012.

(51) Int. Cl. G06Q 20/12; G06F 17/24

(52) U.S. Cl. CPC G06Q 20/12; G06F 17/243
USPC 705/39

(57) ABSTRACT

A system and method for fraud prevention is provided. This system and method may comprise a form filing application. Form filling application may comprise enhanced authorization data capture capabilities. A system for transmitting an authorization request and a request for fraud services to a transaction account issuer is disclosed. The transaction account issuer may combine the authorization request and request for fraud services with additional enhanced authorization data to create an authorization response.

### CROSS-REFERENCE TO RELATED APPLICATIONS

This application is a Continuation-In-Part of, claims priority to and the benefit of, U.S. patent application Ser. No. 11/866,009, entitled “MODULAR ELECTRONIC WALLET” and filed on Oct. 2, 2007. This application is also a Continuation-In-Part of claims priority to and the benefit of U.S. patent application Ser. No. 13/708,422, entitled “AUTHENTICATION USING DYNAMIC CODES,” filed Dec. 7, 2012. The '422 application is a continuation-in-part of, and claims priority to and the benefit of, U.S. patent application Ser. No. 13/604,976 titled “AUTHENTICATION USING DYNAMIC CODES (fka SMARTPHONE BARCODE TRANSACTIONS)” filed on Sep. 6, 2012. All of which are incorporated herein by reference in their entirety for all purposes.

### FIELD

The present disclosure generally relates to electronic payments using transaction accounts.

### BACKGROUND

Inputting personal information into Internet web page forms is often a repetitive and time-consuming process. For example, in the online shopping context, a consumer wishing to complete a checkout process at a merchant's website may likely input most or ail of the following information: first name, last name, middle initial, street address, billing address, telephone number, e-mail address, and financial transaction account information. This information may not be the same each time a shopper conducts an online purchase. For example, a shopper may use different credit cards for various purchases. Thus, each time the consumer wishes to purchase from another online merchant, a consumer inputs the same or similar information to complete the online checkout process.

This manual entry of information into online forms is tedious and fraught with the likelihood of omissions and input errors. For example, a shopper typing payment information into a checkout webpage may forget to complete some of the fields in the online form. This error may result in losing all of the typed information, if a user then presses the “back” button in a web browser, frustrating a user and increasing the time to complete the data input. In online shopping, such errors may go undetected by the shopper until after the checkout process is completed and the shopper may only be notified at a later time by the merchant that the information is incomplete or erroneous. In such a case, these problems could lead to an online shopping order being delayed or possibly canceled.

In addition, a person inputting information into Internet web pages may have different sets of information that they wish to input for different web pages. For example, in online shopping, a shopper may have multiple credit cards that they use for different purposes, for example, to get an extended product warranty, to maximize loyalty points, or to earn cash back bonuses for specific types of purchases. In such a case, a shopper inputs the information into the web page that is relevant for the specific credit card for that purchase type. This manual process again is typically time consuming and fraught with error.

A further problem with existing web page input methods is that the user inputting the information must either input from memory, transcribe from another source (such as from a credit card), or “cut and paste” the information into the online fields from an electronic document (e.g., a text editor or word processor). In the case of online shopping, this typically means that a shopper has to search for a credit card from a wallet or a purse, and then transcribe the information into the web page, field by field. A shopper that uses a specific credit card for only limited purposes may forget to use the card, or may inadvertently not use the card at all.

In addition, in the context of online shopping, a shopper frequently must have physical possession of the credit card in order to read the information to input. Alternatively, a shopper could store the information locally on a storage medium, such as in a file locally stored on a computer hard disk drive, and cut and paste the information into the webpage. However, this may be undesirable because the information stored on the computer may not be secure from other users. In addition, cutting and pasting pieces of information into a web page is also tedious and error prone.

Therefore, it would be useful to be able to automate the input of information into web pages in a flexible and secure manner such that the time it takes to input information into webpage fields is reduced and the information used can be tailored to the webpage automatically by the user. More specifically, in the Internet shopping context, it would be useful to be able to allow a shopper to have a way of securely pre-storing transaction card information for the shopper's transaction cards and presenting the shopper with all of their transaction card information such that they can automatically input all purchase information into any Internet checkout webpage for the specific transaction card selected for the purchase.

### SUMMARY

Methods and systems described herein enable fraud assessment capabilities on form filled information, without additional merchant system integration. According to various embodiments, the method may include receiving log in information to access a financial institution system. The log in information may be transmitted via a financial institution form filling tool bar application to the financial institution system. The to in information may be remotely verified by the financial institution. Access to the financial institution form filling tool bar application may be permitted in response to verification of the log in information. A user may select a transaction account, such as via an icon, to populate a merchant electronic form with transaction information. The transaction information may be remotely stored by the financial institution system. Transaction information, such as any information requested by the electronic forms, may be populated by the financial institution form filling tool bar application after being transmitted from the financial institution system. This Transaction information may be remotely stored by the financial institution.

According to various embodiments, a dynamic security code may be requested by the financial institution form filling tool bar application from the financial institution system. This dynamic security code may be populated into a static security code field of the merchant electronic form.

According to various embodiments, the method may include passively collecting enhanced authorization data associated with the merchant electronic form. The method may include transmitting the enhanced authorization data directly to a transaction authorization system for fraud assessment. A merchant may transmit the transaction information to the transaction authorization system in a transaction authorization request message for transaction authorization. The transaction authorization system may associate the transmitted enhanced authorization data to the transaction authorization request for fraud assessment purposes. Directly transmitted enhanced authorization data may bypass being transmitted to a merchant website. Thus, the system needs no merchant integration to function. As used herein, directly transmitted enhanced authorization data from the financial institution form filling tool bar application to the financial institution system eliminates merchant integration in the transmission. Passively collecting may include collecting without at least one of active prompting and response by a user. The financial institution form filling tool bar application may be accessed by a user via a user computing device. Data keyed into fields by a user may be collected, such as passively collected, for fraud assessment purposes.

According to various embodiments, at least a portion of the transaction information populated to the merchant electronic form is captured and stored by the financial institution in association with a transaction account application process. Thus, a user need not enter their form filling information into a form filling application. The financial institution already possesses this information, such as when a user applies for and/or updates their transaction account information. Thus, reducing errors and increasing convenience and confidence in the transaction. A proxy account number may be received and populated into a transaction account field of the merchant electronic form of the merchant website by the financial institution form filling tool bar application. The proxy account number may be associated with a transaction authorization request for fraud assessment purposes.

According to various embodiments, a system is described including receiving log in information to a financial institution system. The log in information may be transmitted via the processor to the financial institution system. The log in information may be remotely verified by the financial institution. A web browser integrated with a form filling capability may be enabled in response to verification of the log in information. A user selection of a transaction account to populate an electronic form of a merchant website with transaction information may be received. The transaction information may be stored remotely by the financial institution. The remotely stored transaction information may be populated into a merchant electronic form of a merchant website in response to the user selection. The remotely stored transaction information may be transmitted from the financial institution system

A merchant may transmit the transaction information to a transaction authorization system in a transaction authorization request message for transaction authorization and fraud assessment. The transaction authorization system may link/associate the transmitted enhanced authorization data to the transaction authorization request, such as for fraud prevention assessment.

The method may include the user tool bar application requesting a dynamic security code (“DSC”) from a transaction authorization system. The user tool bar application may populate the DSC received from the transaction authorization system into a static security code field of a merchant website. The enhanced authorization data transmitted to the transaction authorization system via the user tool bar application may include enhanced authorization data not included in the transaction request message. The enhanced authorization data may be stored in a queue by a transaction authorization system for associating with the transaction request message.

The enhanced authorization data may include a URI of a merchant website. This URL of a merchant website may be used to retrieve a profile of the merchant. This profile may inform a fraud assessment. A merchant classification code may be associated with the URL for informing the fraud assessment.

According to various embodiments, the method may include passively capturing a first record of data filled in forms of a merchant website substantially in response to data being populated into the forms and passively capturing a second record of data populated in the forms of the merchant website, substantially in response to the changing of a webpage having the forms. These records (e.g. the first record of data to the second record of data) may be compared for changes, such as for fraud assessment purposes. The method may include passively capturing data keyed into fields by a user for fraud assessment purposes and/or feedback tool honing purposes.

According to various embodiments, a system further described herein may include: a receiving module in communication with the processor, wherein the receiving module is configured to receive log in information to a financial institution system, wherein the log in information is transmitted via the processor to the financial institution system, wherein the log in information is remotely verified by the financial institution system; an enabling module in communication with the processor, wherein the enabling module is configured to enable web browser integrated form, filling, in response to the verification of the log in information; the receiving module is further configured to receive a user selection of a transaction account to populate an electronic form of a merchant website with transaction information, wherein the transaction information is stored remotely by the financial institution; and a populating module in communication with the processor, wherein the populating module is configured to populate, in response to the user selection, the transaction information into a merchant electronic form of a merchant website, wherein the transaction information comprises a dynamic security code received from the financial institution system, wherein the remotely stored transaction information is transmitted from the financial institution system; and an enhanced authorization data module in communication with the processor, wherein the enhanced authorization data module is configured to enable passive collection of enhanced authorization data without merchant integration.

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and:

FIG. 1 is a flow chart illustrating exemplary systems for automated data entry and fraud assessment, in accordance with various embodiments;

FIG. 2 is a flow chart illustrating an exemplary process for automated data entry and fraud assessment, in accordance with various embodiments; and

FIG. 3 depicts an exemplary computer based system applicable with various embodiments.

### DETAILED DESCRIPTION

The detailed description of exemplary embodiments herein makes reference to the accompanying drawings and pictures, which show the exemplary embodiment by way of illustration. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

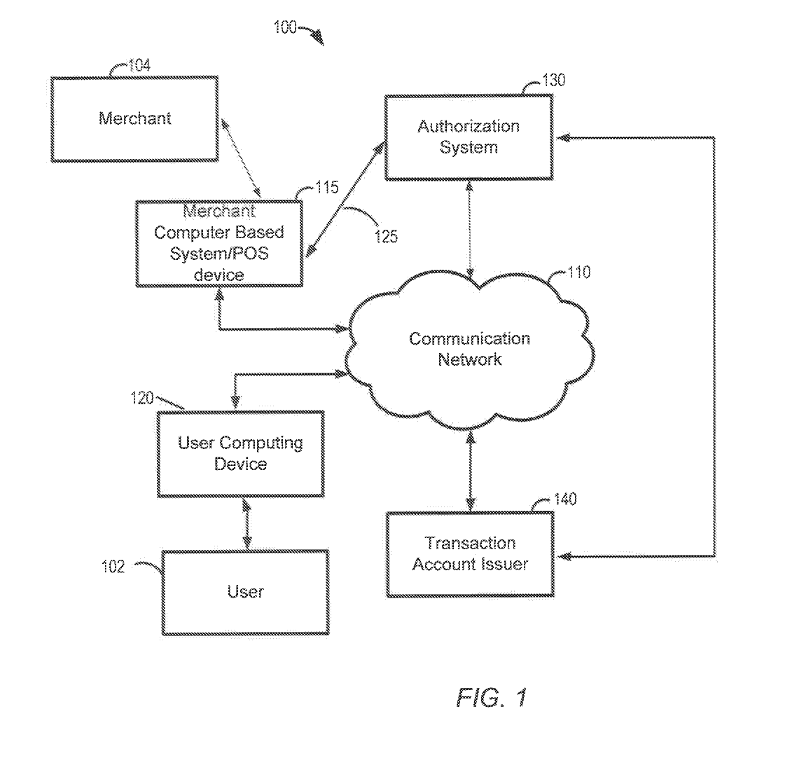

Referring to FIG. 1, according to various embodiments, the systems may include an entity, such as a user 102 comprising a user computing device 120, a merchant 104 comprising a merchant computer based system 115, an authorization system 130, and various databases. The user computing device 120, merchant computer based system 115, and authorization system 130 may be coupled together through one or more communication networks 110. Authorization system 130 may include gateway 125 for receiving 1100 formatted messages, such as 1100 formatted messages from merchants 104. Authorization system 130 may also receive data directly from user computing device 120, such as via communications network 110.

Authorization system 130 may send data (e.g., value added services) to a transaction account issuer 140 and/or to a financial institution to assist with an authorization decision. The databases may include account holder database and a transaction database. User 102 may interact with merchant 104 (e.g., merchant system 115) to make a purchase using a transaction account. Merchant 104 may request authorization to accept the transaction account code as payment by sending a request to authorization system 130, such as over gateway 125 (e.g., according to various payment account industry standards).

Authorization system 130 may perform risk analysis on the request using information, for example, from the account holder database and the transaction database. Based on the risk analysis, authorization system 130 may create an authorization decision to approve, deny or refer the request. The authorization decision is provided to merchant 104. This authorization decision may be provided to merchant 104 through gateway 125, such as via a proprietary payment network. Merchant 104 may complete the transaction if the request is approved, verify that the merchant 104 is able to or desires to complete the transaction and/or may ask for an alternative form of payment from user 102 if the request is denied. If the request is referred, merchant 104 may contact the transaction account issuer 140 or ask user 102 to contact the transaction account issuer 140 to provide additional information to have the request approved.

A user 102 may interact with merchant 104 from a user computer device 120 via the Internet (e.g. communications network 110) to complete the transaction (e.g. to make a purchase). When communicating with merchant 104 through a telephone or a computer (e.g., using a web enabled computer, kiosk, terminal or the like), user 102 may provide information associated with a transaction instrument (e.g., transaction account number or code, expiration date, account name, and billing address) to merchant 104 to make a payment.

Along with providing a transaction instrument and/or transaction account information as payment, user 102 may provide additional information to merchant 104 in response to conducting a purchase. For example, user 102 may provide a ship-to-address or a ship-to-name that may be different than a name or billing address associated with the transaction instrument. User 102 may provide an email address or a contact telephone number to merchant 104 so that user 102 may be updated with the status of a purchase.

According to various embodiments, authorization system 130 and/or transaction account issuer 140 may perform an authorization decision. In various embodiments, authorization system 130 and/or transaction account issuer 140 may compare the enhanced authorization data (as described further below) with data in a risk database. For example, the data in the risk database may indicate that the IP address associated with the enhanced authorization information (e.g. user computing device) has been used to commit fraud in the past. In various embodiments, the risk database may contain data associated with any of the enhanced authorization data indicating positive or negative fraud risks associated with the transaction. Authorization system 130 and/or transaction account issuer 140 may use the information in the risk database in determining whether to approve or decline the authorization request.

The transaction account issuer 140 may transmit an authorization response indicating an approval or denial of the authorization request. In various embodiments, the authorization response is transmitted to the merchant 104 through at least one of the gateway 125. The merchant 104 may transmit an approval or denial message to the entity. In various embodiments, the transaction account issuer 140 may transmit separate authorization responses to the merchant 104 and user 102. The authorization response may be received by a hardware component on a user computing device 120 of user 102. Hardware components may include personal computers, mobile phones, tablet devices, or any other device capable of communicating with communications network 110. p According to various embodiments, a system and method is disclosed which is coupled to electronic wallet functionality and/or a form filling program that causes a computer based system to enable a user to make an electronic payment via a communication network. User 102 may provide, via a logon interface on a display screen of the computer, user credentials. The system may receive logon information inputted by user 102. In response to logging in and/or selecting a transaction account for payment, form filling on an associated merchant 104 website may commence. The entered form filling information, such as information entered by the computer based system, may be passively captured/collected and/or transmitted for fraud prevention purposes. Passively captured/collected as used herein may refer to without additional prompting and/or response by user 102 and/or merchant system 115.

Initially, a transaction account holder, such as user 102, may download a form filling application 100 to a computing device. This computing device may be a computer, tablet, mobile device, smart phone, interactive television and/or the like.

Form filling application 100 may comprise enhanced authorization data capture/collection capabilities. Examples of enhanced authorization data include, for example, an automatic number identification (ANI), an email address, cookies, a contact telephone number, a ship-to-name, a ship-to-address, ship-to-store indicator, ship-to-store zip code, email address host, custom hostname, HTTP browser type, ship to country, URL of the merchant, shipping method, product SKU, number of cities, an IP address, a seller identification, and/or descriptors of goods or services associated with the transaction.

The enhanced authorization data may include at least one of user 102 name; passenger name; a national identification code associated with a particular country (such as a social security number), date of birth, a travel date; a routing description; an electronic ticket indicator; an origin city; a destination city; log in score, a class of service; a number of passengers; a reservation code; and/or carrier code. The enhanced authorization data may be provided in whole or in part, for instance providing only the last four digits of a social security number. In various embodiments, when a partial enhanced authorization data entry is provided, a computer based system may compare the partial entry against a database record for the associated user 102 and retrieve the complete enhanced authorization data record.

Enhanced authorization data may be additional data elements that allow a transaction processor/fraud prevention tool to make a decision with a higher confidence. For example, an IP address known to be associated with a user computer associated with a known user may grant a higher confidence that the user is in fact intentionally using their transaction account in this transaction. In another example, receiving a cookie associated with a form filling application 100 which is associated with the correct transaction account holder may give a higher confidence that the transaction is free of fraud. According to various embodiments, a score, associated with this confidence level, may be assigned to the logon event based on various logon data.

For example, a score such as score within the range of 0-1000 may be assigned to a user's logon event. The score may be based on matching elements of the logon data with previously known/established data points. For instance, cookies associated with a known user computing device, cookies associated with programs stored on the user computing device, IP addresses associated with the user computing device, number of password attempts, number of username attempts, correct password, time of day, country code associated with data transmission, and/or correct username may be associated with a logon event. A subset of these elements may be joined into a composite group to form a score. The score may be used to authenticate a logon. The score may be used as part of a fraud risk decisioning process associated with a transaction authorization decision, such as part of enhanced authorization information.

Form filling application 100 may comprise a tool bar widget for use with an Internet web browsing program, such as a browser toolbar and/or a specialized tablet application. Form filling application 100 may be hosted by a transaction account issuer 140, financial institution, and/or a third party. Form filling application 100 host may store preference and/or user information of a user. This information may include shipping addresses, billing addresses, shipping names, billing names, contact information, such as telephone contact information, email contact information, social media identifiers, transaction account codes, transaction instrument expiration date, a dynamic security code, such as a transaction instrument security code (CID), and/or the like.

In various embodiments, the system may comprise use of a dynamic security code (“DSC”) and interfacing with a dynamic security code generator (“DSCG”). DSCG may generate one or more dynamic security codes (“DSC”) for a transaction account. A DSC may be used by a party involved in processing a transaction request in order to make a decision whether to authorize or deny the transaction request. In various embodiments, DSCs may be used in place of various existing card security codes, such as a CVC1, CVV1, CVV2, CVC2, CCID, CID, iCVV or Dynamic CVV, which are often a 3 or 4 digit number located on the front or back of a transaction card. The DSCs may comprise a 5-digit security code. The DSCs may comprise any number of digits, alphanumeric characters, indicators, or any other symbols. In various embodiments, the DSCs may be randomly generated. The DSCs may be dynamic single-use security codes. DSCG may comprise a unique code for each consumer that generates DSCs randomly. The generated DSC code may be associated with a specific transaction account, such that the DSCs may only be used in connection with the specific transaction account. However, in various embodiments, the code may be a customer level code, such that a DSC generated by the code may be used in connection with multiple transaction accounts associated with the consumer, DSCG may store a plurality of DSCs for a transaction account. The DSCs may be stored in a database, table, list, or any other storage area capable of storing one or more. DSCs. In various embodiments, the DSCs may be stored such that some or all of the DSCs are simultaneously active. However, in various embodiments, the DSCs may be stored in an ordered queue, such that only the DSC which is first in the queue is active. The use of dynamic security codes is further described in U.S. Pat. No, 7,849,014 entitled “SYSTEM AND METHOD FOR FACILITATING A FINANCIAL TRANSACTION WITH A DYNAMICALLY GENERATED IDENTIFIER,” filed on Aug. 29, 2007, the contents of which are hereby incorporated by reference for any purpose in its entirety.

Preference and/or user information may include information likely to be requested in fillable forms by merchants in virtual point of sale websites. This information may be stored in a remote host database A user may designate preferences for default transaction accounts and/or shipping addresses. These defaults may be, for example, merchant specific, product or service specific, and/or dollar amount specific.

Transaction account issuer 140 hosting the storage of preference and/or user information eliminates the concern of local user storage and/or a third party storing transaction account numbers and/or transaction instrument security codes. The third party storage and/or user storage of sensitive information may be a security concern. Also, third party/user storage of various information may not be compliant with PCI data security standards.

Form filling application 100 may comprise algorithms and/or programming to identify fields capable of being filled with preference and/or user information. This identification may be regardless of position and/or order of the fields on the merchant 104 website 115. Thus, form filling application 100 is suitably robust to identify fields in merchant 104 website 115 requiring form filled information regardless of form or layout of the electronic forms. The algorithm and/or programming of form filling application 100 may comprise feedback loop. For instance, should a field not be recognized by form filling application 100 and user 102 need to hard enter information in the field, form filling application 100 may save a record of this phenomena. The algorithm and/or programming may be updated to eliminate these instances. Form filling application 100 may comprise algorithms and/or programming that is stored locally, in a cloud, and/or by the host.

Additionally, a user 102 making a change, such as by deleting and keying information into a field previously entered with information by form filling application 100 may be passively captured by form filling application 100. These changes in information may indicate that form filling application 100 information is out of date and/or an instance of fraud occurring. According to various embodiments, information entered into forms/fields by form filling application 100 may be captured at the time it is entered, prior to user 102 advancing to an new webpage, in response to a request to advance to an new webpage, in response to submitting a purchase request, in response to submitting information to the merchant 104 and/or at any time. Multiple instances of entered and/or transmitted captured information may be compared against each other for fraud prevention/calculation.

Importantly, while form filling application 100 may be used by a computing device, it does not involve direct merchant 104 integration. For instance, merchant 104 may have no knowledge that form filling application 100 is being used to complete a transaction. The transaction may be paying a bill, such as, for example, from a service utility. The transaction may also be for completing an online shopping transaction. Merchant 104 need not undergo any change to its interfaces and/or backend systems for interaction with form filling application 100.

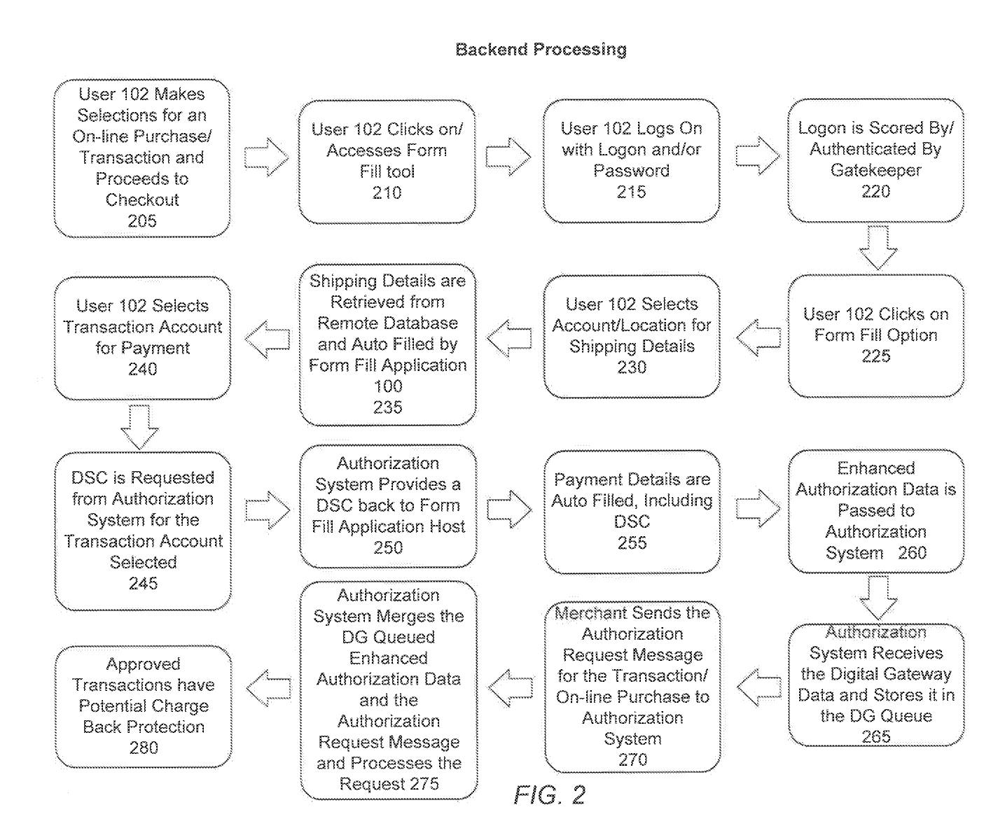

According to various embodiments and with reference to FIG. 2, a process for completing a transaction using form filling application 100 is outlined. For instance, user 102 may have previously downloaded and installed form filling application 100. Preference and/or user information may be known to and stored by the host system based on prior historical activity. This historical activity may be information populated to a user account, such as information associated with the establishing of a financial transaction account for the user. In this way, a user does not have to re-enter their ship-to-information, contact information, transaction account information, and/or the like after downloading the form tilling application 100. This information may be known a priori to the host system. User 102 may browse a website, such as a virtual POS site 115, of a merchant 104. User 102 may select items for purchase. User 102 may proceed to a checkout page of the merchant 104 virtual POS site 115 (step 205). User 102 may select, such as via a virtual toggle button, form filling application 100, such as from the browser toolbar (step 210). Form filling application 100 may request a user name and/or password by presenting a tillable blank on a user interface via a display to user 102 (step 215). This username and/or password may be the same username and/or password as is used to access additional tools and services of form filling application 100 host. In response to being entered by user 102, the logon information may be transmitted via a network to a gatekeeper for authorization and/or verification (step 220).

In response to the user being authorized, the user may select a form filling option of form filling application 100 (step 225). This selection may be by selecting an icon of a transaction account and/or selection of an icon of a pre-stored shipping address (step 230, 240). In response to this selection, transaction account details and shipping information may be retrieved from the form filling application 100 host database (step 235). Form filling application 100 host database may be stored remote from the user computing device, such as via cloud storage. A DSC of the transaction account selected may be requested from by the farms filling application 100 host to a transaction account issuer 140/authorization system 130 (step 245). The transaction account issuer 140/authorization system 130 may provide a DSC to form filling application 100 in response to the request (step 250). The DSC may be available for use for a selected period of time, such as until they expire. According to various embodiments, multiple DSCs may be available for use by user 102 at a given time provided they have not yet expired. Example timeframes for DSC expiration may be 10 minutes, 15 minutes, and 20 minutes.

The fields that are known to form filling application 100 may be populated with data, including the DSC by form filling application 100 (step 255). The code of the DSC is not the same code as the static security code that is printed on a transaction instrument. Thus, in response to merchant 104 data being inadvertently exposed, the transaction account information will be of limited value as the DSC is only valid with the particular transaction account for a limited period of time. In various embodiments, a DSC may include aspects as disclosed in pending U.S. patent application Ser. No. 13/708,422, entitled “AUTHENTICATION USING DYNAMIC CODES,” filed Dec. 7, 2012; which is a continuation-in-part of and claims priority to U.S. application Ser. No, 13/604,976 titled “SMARTPHONE BARCODE TRANSACTIONS” and filed on Sep. 6, 2012, both of which are incorporated herein by reference in their entirety for any purpose.

Enhanced authorization data filled in the electronic form, such as a the data auto-filled in the form by form filling application 100, may be passively captured and passed directly to the authorization system 130 by form filling application 100 (step 260). In other words, transmitted directly from form filling application 100 computing device 120 may be without being transmitted first to a merchant 104 and/or merchant system 115. This may occur prior to the user transmitting the checkout page information, including the information entered in the finable forms to the merchant 104. This data may be encrypted. The sent enhanced authorization data may be captured by the authorization system 130 and stored in a queue. User 102 may transmit the checkout page information, including the information entered in the tillable forms to the merchant 104 (step 265). Merchant 104 may transmit a transaction authorization request message, such as an 1100 authorization request message as detailed in ISO 8583 via a merchant POS/computer based system 115, to authorization system 130 associated with the received transaction information (step 270). Authorization system 130 may merge the queued enhanced authorization information with the authorization message and process the request (step 275). The approved transaction may have charge back protection based on this procedure (step 280).

The authorization request may be sent to authorization system 130 and/or transaction account issuer 140 over, for example, a telephone network, intranet, the Internet, wireless communications, application program interface (API) and/or the like. A fraud assessment may be performed on and/or associated with the authorization request. A fraud assessment may be performed at any time. For instance, it may be performed when enhanced authorization data is received, in response to receipt of a transaction authorization request, after receipt of a transaction authorization request, and/or prior to an authorization request being sent. Also, a fraud assessment may performed by an account issuer 140/authorization system 130/third party at any time, with or without an associated accompanying transaction authorization request, such as in response to the enhanced authorization data being passively collected/transmitted.

Use of form filling application 100 does not require establishing user accounts with multiple disparate merchant sites. Nor does a user need to remember a multitude of disparate merchant site logon or password information.

According to various embodiments, once logged in to form filling application 100, a user may easily retrieve additional transaction account information. This may be for example, a current balance, reward points balance, minimum payment, and payment due date. Based upon the user's preferences, some or all of this information may be displayed on the toolbar as an object after logging in to the system. A user can create a profile, in a remote host database for each transaction account for used by the system and input and store personal information that they choose to associate with the account for the purpose of inputting information into fillable web pages.

According to various embodiments, in response to logging in to the form filling application 100, the IP address associated with the user may be captured and verified as a first fraud check and/or authentication verification. Additionally, a cookie associated with form application 100 stored by the user computing device and in a lookup table by a remote host may be captured and verified. These may operate as device and network identifiers that are known to be associated with a user.

As previously mentioned, the enhanced authorization data that is captured by form filling application 100 and sent directly to authorization system 130 may be stored in a queue. This information may be combined with the authorization message sent by merchant 104 at any time. They may be combined by linking transaction account information and/or other common identifiers.

As previously mentioned, the enhanced authorization data may comprise a URL of a merchant 104. This data informs authorization system 130 which merchant 104 the user may be attempting to perform a transaction. This URI, may be associated to and/or translated into a merchant number. The merchant number allows authorization system 130 to access a profile of this merchant 104. This profile may comprise historical information, such as historical instances of fraud which may color an authorization decision.

As previously mentioned, according to various embodiments, a DSC may be provided by form filling application 100. Thus, in response to form filling application 100 determining transaction account information is needed on the website 115 of merchant 104, a DSC may be requested, This DSC, once generated, may he populated to the merchant 104 webpage 115. In response to the transaction request being sent by the merchant 104, via the 1100 message, to authorization system 130, the DSC will be received from the security code field. Thus, the merchant 104 need not alter their system 115, however authorization system 130 may match and/or link the DSC to the static security code, such as a the static security code imprinted on an associated transaction instrument, for the transaction. Thus the DSC may act as a token of validation that this transaction was originated in a known toolbar. This may provide confidence in approving the transaction as to use the toolbar the user has provided accurate form filling application 100 login and/or password, with accurate form filling application 100 cookie and/or IP address.

According to various embodiments, a proxy account number/code may be entered by form filling application 100 in lieu of the actual transaction account number. This proxy account number may be linked to the user transaction account for authorization and settlement. A card authorization system (CAS), generally hosted by a transaction account processor and/or issuer, may issue a proxy account number to be populated by form filling application 100. According to various embodiments, the proxy account number may be used in the specific form for which it was created. A backend system may link/associate data elements of the electronic form/user identifier and the generated proxy account number and compare this information to received proxy account numbers, user identifiers, transaction requests, and/or electronic forms for authorization.

According to various embodiments, use of the form filling application 100 may earn the user a membership reward bonus, in various embodiments of form filling application 100, the size of an associated toolbar module can be increased or decreased in response to activation of a sizing icon located in or on the toolbar by the user. When the size of a module is increased, the amount of information displayed in the module also increases. When the size of a module is decreased, the amount of information displayed in the module decreases. Such as current balance and/or reward point information.

According to various embodiments, the capabilities of form filling application 100 may be integral to a web browser application and/or a web browsing application may be integral to form filling application 100. Thus, no additional downloading of form filling application 100 is needed. The functionality of form filling application 100 is integral to a web browsing application. For instance, a user may log in to a web browsing application or a program associated with a web browsing application and have full form filling application 100 functionality available when browsing merchant websites. Thus, the web browsing application may passively collect enhanced authorization data and/or securely populate electronic forms with a DSC. The web browsing application may partner with and/or communicate with a transaction issuer and/or processor to collect enhanced authorization data and populate forms with a DSC.

The present system or any part(s) or function(s) thereof) may be implemented using hardware, software or a combination thereof and may be implemented in one or more computer systems or other processing systems. However, the manipulations performed by the present disclosure were often referred to in terms, such as adding or comparing, which are commonly associated with mental operations performed by a human operator. No such capability of a human operator is necessary, or desirable in most cases, in any of the operations described herein which form part of the present disclosure. Rather, the operations are machine operations. Useful machines for performing the operation of the present disclosure include general purpose digital computers or similar devices.

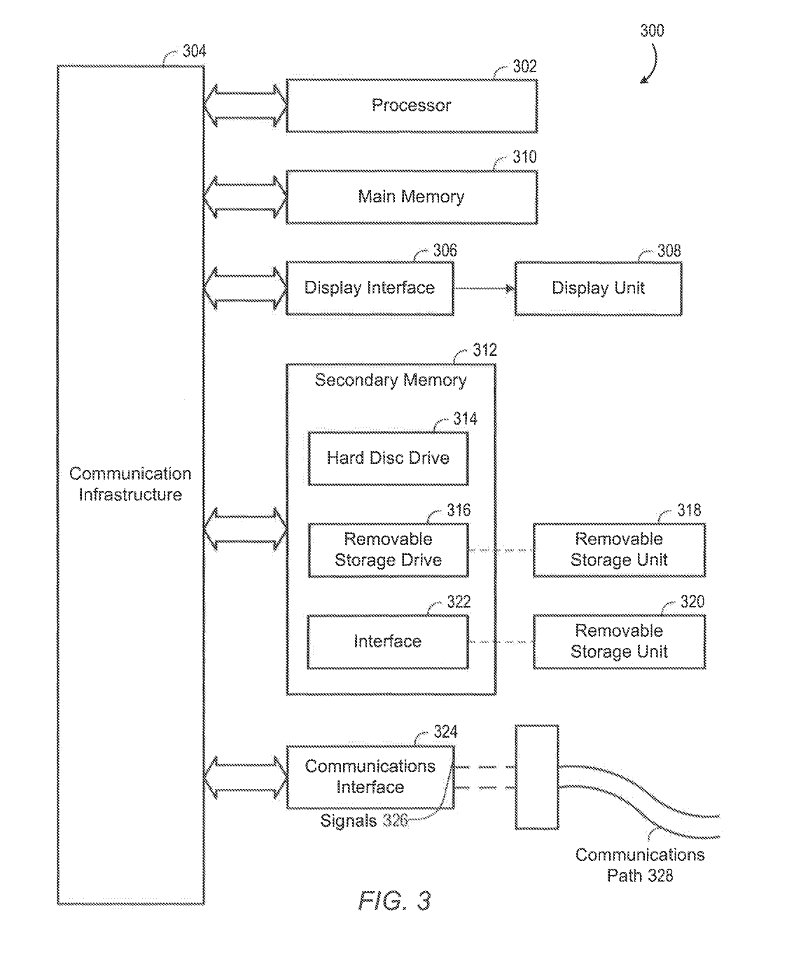

In fact, in one embodiment, the system is directed toward one or more computer systems capable of carrying out the functionality described herein. An example of a computer system 300 is shown in FIG. 3.

The computer system 300 includes one or more processors, such as processor 302. The processor 302 is connected to a communication infrastructure 304 (e.g., a communications bus, cross-over bar, or network). Various software embodiments are described in terms of this exemplary computer system. After reading this description, it will become apparent to a person skilled in the relevant art(s) how to implement aspects of the disclosure using other computer systems and/or architectures.

Computer system 300 can include a display interface 306 that forwards graphics, text, and other data from the communication infrastructure 304 (or from a frame buffer not shown) for display on the display unit 308.

Computer system 300 also includes a main memory 310, preferably random access memory (RAM), and may also include a secondary memory 312. The secondary memory 312 may include, for example, a hard disk drive 314 and/or a removable storage drive 316, representing a floppy disk drive, a magnetic tape drive, an optical disk drive, etc. The removable storage drive 318 reads from and/or writes to a removable storage unit 318 in a well-known manner. Removable storage unit 318 represents a floppy disk, magnetic tape, optical disk, etc. which is read by and written to by removable storage drive 316. As will be appreciated, the removable storage unit 318 includes a computer usable storage medium having stored therein computer software and/or data.

In alternative embodiments, secondary memory 312 may include other similar devices for allowing computer programs or other instructions to be loaded into computer system 300. Such devices may include, for example, a removable storage unit 320 and an interface 322. Examples of such may include a program cartridge and cartridge interface (such as that found in video game devices), a removable memory chip (such as an erasable programmable read only memory (EPROM), or programmable read only memory (PROM)) and associated socket, and other removable storage units 320 and interfaces 322, which allow software and data to be transferred from the removable storage unit 320 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals 326 which may be electronic, electromagnetic, and optical or other non-transitory signals capable of being received by communications interface 324. These signals 326 are provided to communications interface 324 via a communications path (e.g., channel) 328. This channel 328 carries signals 326 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 316, a hard disk installed in hard disk drive 314, and signals 326. These computer program products provide software to computer system 300. This disclosure may be directed to such computer program products.

Computer programs (also referred to as computer control logic) are stored in main memory 310 and/or secondary memory 312. Computer programs may also be received via communications interface 324. Such computer programs, when executed, enable the computer system 300 to perform the features of the present disclosure, as discussed herein. In particular, the computer programs, when executed, enable the processor 302 to perform the features of the present disclosure. Accordingly, such computer programs represent controllers of the computer system 300.

in implementing the disclosure using software, the software may be stored in a computer program product and loaded into computer system 300 using removable storage drive 316, hard drive 314 or communications interface 324. The control logic (software), when executed by the processor 302, causes the processor 302 to perform the functions of the disclosure as described herein.

In various embodiments, the disclosure is implemented primarily in hardware using, for example, hardware components such as application specific integrated circuits (ASICs). Implementation of the hardware state machine so as to perform the functions described herein will be apparent to persons skilled in the relevant art(s). In yet various embodiments, the disclosure is implemented using a combination of both hardware and software.

In various embodiment personal information, including preference information, is stored as encrypted data in order, among other things, to prevent unauthorized access to the user's personal information stored on a user's the computer readable storage medium. The information cannot be edited or stored unless the user has been authenticated to the server computer from the main login screen, described above.

In various embodiments, form filling application 100, during a period of inactivity, may stop executing and not permit a user to automatically input personal information into finable fields until the user re-logs into the system again. In one embodiment of form filling application 100, the program can be configured to minimize the toolbar icon and enter a standby mode. While in the standby mode a visual indicator can be present on a portion of the display. During the period of inactivity this indicator can change state or disappear indicating a timeout, and therefore, that the user is no longer able to use the toolbar without authenticating himself with the system again.

In various embodiments, authorization system 130 may be hosted by a transaction account issuer 140 and/or financial institution.

Phrases and terms similar to an “entity” may include any individual, consumer, customer, group, business, organization, government entity, transaction account issuer or processor (e.g., credit, charge, etc.), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

Phrases and terms similar to “transaction account” may include any account that may be used to facilitate a financial transaction (e.g., credit, debit, stored value, gift, phone, smart, RFID, and/or other accounts and instruments).

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “financial transaction instrument,” “transaction instrument” and/or the plural form of these terms may be used interchangeably throughout to refer to a financial instrument.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

Phrases and terms similar to an “item” may include any good, service, information, experience or anything of value.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “processor” (such as a payment processor) may include a company (e.g., a third party) appointed (e.g., by a merchant) to handle transactions for merchant banks. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction.

Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

Phrases similar to “vendor software” or “vendor” may include software, hardware and/or a solution provided from an external vendor (e.g., not part of the merchant) to provide value in the payment process (e.g., risk assessment).

An example of matching an authorization request to a request for fraud services, as previously described, may comprise transaction account issuer 140 polling the enhanced authorization queue for a request for fraud services corresponding to the received authorization request. In various embodiments, the transaction account issuer 140 may compare fields such as time received, a merchant associated with the message, a transaction account number or a transaction amount of the authorization request with similar fields of a request for fraud services in the enhanced authorization queue. Transaction account issuer 140 may compare any data associated with the authorization request with data in the request for fraud services. For example, transaction account issuer 140 may determine that the time received of authorization request is not within a specified amount of the time received of request for fraud services and determine that request for fraud services does not correspond to authorization request. Transaction account issuer 140 may determine that the data associated with authorization request is sufficiently similar to the data associated with request for fraud services and determine that authorization request and request for fraud services correspond to the same transaction. Transaction account issuer 140 may merge the data of authorization request and request for fraud services to create an enhanced authorization message. Transaction account issuer 140 may use the enhanced authorization message to determine whether to approve or deny the authorization request. In various embodiments transaction account issuer 140 may remove the enhanced data prior to transmitting an authorization response to the merchant 104.

In various embodiments, a fraud assessment may include transmitting enhanced authorization data and/or utilizing fraud tools and/or customer level data as disclosed in pending U.S. patent application Ser. No. 13/411,299, entitled “SYSTEMS AND METHODS FOR ENHANCED AUTHORIZATION FRAUD MITIGATION,” filed Mar. 2, 2012; U.S. patent application Ser. No. 11/303,018, entitled “SYSTEM, METHOD AND COMPUTER PROGRAM PRODUCT FOR AUTHORIZING TRANSACTIONS USING ENHANCED AUTHORIZATION DATA,” filed Dec. 16, 2005; U.S. application Ser. No. 10/588,811, entitled “SYSTEM AND METHOD USING ENHANCED AUTHORIZATION DATA TO REDUCE TRAVEL RELATED TRANSACTION FRAUD,” filed Jun. 11, 2007; and U.S. application Ser. No. 12/205,412, entitled “METHOD, SYSTEM, AND COMPUTER PROGRAM PRODUCT FOR CUSTOMER-LEVEL DATA VERIFICATION,” filed Sep. 5, 2008, the contents of all documents are hereby incorporated by reference for any purpose in their entirety. For instance, a fraud mitigation tool and/or fraud assessment may include a data element (i.e. information that may be known by a financial transaction instrument issuer and/or the customer having a financial transaction instrument issued by the financial transaction instrument issuer as the enhanced authorization data, such as a whole or partial national identification number and/or whole or partial date of birth).

In an embodiment, a fraud mitigation tool and/or fraud assessment may include receiving (from the merchant for use in real-time authorization) transaction variables for a transaction involving a purchase of a travel ticket using a transaction account. The transaction variables may include at least one of a passenger name on the travel ticket, a travel date, a routing description of the travel ticket, and/or an electronic ticket indicator; and processing the transaction variables through a fraud-risk model to determine a risk factor for the transaction. The transaction authorization request may be approved based on the risk factor being within a range of acceptable values. A purchasing history of the account holder may be retrieved from a database. The transaction authorization request may be approved based on the risk factor and the purchasing history. In various embodiments, a status of the transaction account may be retrieved. The transaction authorization request may be approved based on the risk factor and the status. The transaction authorization request may be declined in response to the risk factor being within a range of unacceptable values.

In an embodiment, the fraud mitigation tool and/or a fraud assessment may include receiving a first data element including first transaction account data identifying a first transaction account, and receiving a second data element. An entity may be determined from the first transaction account data. A second transaction account associated with the entity may be identified. A determination that the second data element does not match a corresponding data element associated with the first transaction account may be made. The second data element may be compared with an entity record including second transaction account data identifying the second transaction account. The second transaction account data may be compared with the first transaction account data. A comparison result may be generated to verify the first data element based on the comparing. The comparison result may indicate that the entity is associated with an account corresponding to the first transaction account.

In various embodiments, a fraud assessment may include transmitting information associated with products involved with the transaction to identify risk associated with the transaction as disclosed in pending U.S. patent application Ser. No. 12/416,675, entitled “AUTHORIZATION REQUEST FOR FINANCIAL TRANSACTIONS,” filed Apr. 1, 2009; the contents of which are hereby incorporated by reference for any purpose in their entirety. For instance, a fraud mitigation tool and/or a fraud assessment may include automatically identifying at least one product from a purchase order associated with the transaction, the identification being performed based on an electronic comparison between a predefined list of products and the purchase order. A fraud mitigation tool and/or fraud assessment may include sending product details of the product through a third party (such as with an authorization request) to the financial institution. In this embodiment a notification may be received from the financial institution and/or through a third party, wherein the notification includes an authorization decision based on the product details. In this embodiment, the predefined list of products may be defined by the financial institution and/or transaction account issuer 140. The predefined list of products may be defined based on financial risk associated with a plurality of products. A unique code may be associated with each product in the predefined list of products. The unique code associated may be defined by the financial institution and/or transaction account issuer 140 and may be included as a field in the electronic transaction authorization request.

In various embodiments, a fraud assessment may include transmitting a post-authorization message for a financial transaction as disclosed in pending U.S. patent application Ser. No. 12/416,680, entitled “POST-AUTHORIZATION MESSAGE FOR A FINANCIAL TRANSACTION,” filed Apr. 1, 2009 the contents of which are hereby incorporated by reference for any purpose in their entirety.

One skilled in the art will also appreciate that, for security reasons, any databases, systems, devices, servers or other components described herein may consist of any combination thereof at a single location or at multiple locations, wherein each database or system described herein includes any of various suitable security features, such as firewalls, access codes, encryption, decryption, compression, decompression, and/or the like.

In addition to those described above, the various system components discussed herein may include one or more of the following: a host server or other computing systems including a processor for processing digital data; a memory coupled to the processor for storing digital data an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation. As those skilled in the art will appreciate, user computer may include an operating system (e.g., Windows NT, 95/98/2000, OS2, Linux, Solaris, MacOS, etc.) as well as various conventional support software and drivers typically associated with computers. The computer may include any suitable personal computer, network computer, workstation, minicomputer, mainframe or the like. User computer can be in a home or business environment with access to a network. In an exemplary embodiment, access is through a network or the Internet through a commercially-available web-browser software package.

In various embodiments, components, modules, and/or engines may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet. Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network. is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

Aspects of the disclosure may be described herein in terms of functional block components, screen shots, optional selections and various processing steps. It should be appreciated that such functional blocks may be realized by any number of hardware and/or software components configured to perform the specified functions. For example, various integrated circuit components, e.g., memory elements, processing elements, logic elements, look-up tables, and/or the like may be included, which may carry out a variety of functions under the control of one or more microprocessors or other control devices. Similarly, any software elements may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted any number of conventional techniques for data transmission, signaling, data processing, network control, and/or the like may be employed with the present system and method. Still further, detection or prevention of security issues with a client-side scripting language, such as JavaScript, VBScript or the like is contemplated with the present system and method. For a basic introduction of cryptography and network security, see any of the following references: (1) “Applied Cryptography: Protocols, Algorithms, And Source Code In C,” by Bruce. Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

Computer program instructions described herein may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a non-transitory computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, may be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

As used herein, “match” or “associated with” or similar phrases may include an identical match, a partial match, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Systems, methods and computer program products for fraud prevention and implementing fraud prevention are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

In various embodiments, the methods described herein are implemented using the various particular machines described herein. The methods described herein may be implemented using the above particular machines, and those hereinafter developed, in any suitable combination, as would be appreciated immediately by one skilled in the art. Further, as is unambiguous from this disclosure, the methods described herein may result in various transformations of certain articles.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those typos of transitory computer readable media which were found in In Re Nuijten to fall outside the scope of patentable subject matter under 35 U.S.C. §101.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of this disclosure is accordingly to be limited by nothing other than the appended claims, in which reference to an element in the singular is not intended to mean “one and only one” unless explicitly so stated, but rather “one or more.” Moreover, where a phrase similar to at least one of A, B, and/or C is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. All structural, chemical, and functional equivalents to the elements of the above-described exemplary embodiments that are known to those of ordinary skill in the art are expressly incorporated herein by reference and are intended to be encompassed by the present claims. Further, a list of elements does not include only those elements but may include other elements not expressly listed or inherent to such process, method, article, or apparatus.

What is claimed is:

1. A computer-implemented method comprising:
receiving, by a financial institution form filling tool bar application, log in information to access a financial institution system, wherein the log in information is transmitted via the financial institution form filling tool bar application to the financial institution system, wherein the log in information is remotely verified by the financial institution system;
permitting, by the financial institution form filling tool bar application, access to the financial institution form filling tool bar application in response to the verification of the log in information;
receiving, by the financial institution form filling tool bar application, a user selection of a transaction account; and
populating, by the financial institution form filling tool bar application and in response to the user selection, transaction information into the merchant electronic form of a merchant website, wherein the transaction information is remotely stored by the financial institution system, wherein the remotely stored transaction information is transmitted from the financial institution system.

2. The method of claim 1, further comprising requesting, by the financial institution form filling tool bar application, a dynamic security code from the financial institution system.

3. The method of claim 2, further comprising populating, by the financial institution form filling tool bar application, the dynamic security code into a security code field of the merchant electronic form, wherein the dynamic security code is received from the financial institution system.

4. The method of claim 1, further comprising:
passively collecting, by the financial institution form filling tool bar application, enhanced authorization data; and
transmitting, by the financial institution form filling tool bar application, the enhanced authorization data directly to a transaction authorization system for fraud assessment,
wherein a merchant transmits the transaction information to the transaction authorization system in a transaction authorization request message for transaction authorization, and wherein the transaction authorization system associates the transmitted enhanced authorization data to the transaction authorization request for fraud assessment purposes.

5. The method of claim 4, wherein the directly transmitted enhanced authorization data from the financial institution form filling tool bar application to the financial institution system eliminates merchant integration in the transmission.

6. The method of claim 4, wherein the passively collecting comprises collecting without at least one of active prompting and response by a user.

7. The method of claim 4, wherein the enhanced authorization data transmitted to the transaction authorization system via the financial institution form filling tool bar application comprises enhanced authorization data not included in the transaction authorization request message.

8. The method of claim 4, wherein the enhanced authorization data is stored in a queue by the transaction authorization system.

9. The method of claim 4, wherein the enhanced authorization data comprises a URL of the merchant website, wherein a profile of the merchant is associated with the URL, and wherein the profile of the merchant is retrieved for informing the fraud assessment.

10. The method of claim 4, wherein the enhanced authorization data comprises a URL of the merchant website, and wherein a merchant classification code is associated with the URL for informing the fraud assessment.

11. The method of claim 4, wherein the enhanced authorization data comprises at least one of a user name, passenger name, a national identification code associated with a particular country, a social security number, date of birth, a travel date, a routing description, an electronic ticket indicator, an origin city, a destination city, a class of service, a number of passengers, a reservation code, and carrier code.

12. The method of claim 4, wherein the enhanced authorization data comprises at least one of a transaction account number, a transaction account issuer, an expiration date, a security code, a billing address, a consumer name, a consumer birth date, a shipping address, a ship-to-name, a shipping method, an email address, ship-to-store identifier, ship-to-store zip code, a telephone number, log in score, an IP address, a service establishment number, a time of a payment request, a customer hostname, an HTTP browser type, and a description of goods.

13. The method of claim 1, further comprising:
passively collecting, by the financial institution form filling tool bar application, a first record of the transaction information populated into the merchant electronic form of the merchant website, substantially in response to data being populated into the merchant electronic form; and
passively collecting, by the financial institution form filling tool bar application, a second record of the transaction information populated into the merchant electronic form of the merchant website, substantially in response to changing from the webpage having the merchant electronic form.

14. The method of claim 13, further comprising comparing, by the financial institution form filling tool bar application, the first record of the transaction information to the second record of the transaction information for fraud assessment purposes.

15. The method of claim 1, wherein the financial institution form filling tool bar application is accessed by a user via a user computing device.

16. The method of claim 1, further comprising passively collecting, by the financial institution form filling tool bar application, data keyed into fields by a user for fraud assessment purposes.

17. The method of claim 1, wherein at least a portion of the transaction information populated to the merchant electronic form is captured and stored by the financial institution system in association with a transaction account application process.

18. The method of claim 1, further comprising at least one of receiving and populating, by the financial institution form filling tool bar application, a proxy account number into a transaction account field of the merchant electronic form of the merchant website, wherein the proxy account number is associated with a transaction authorization request for fraud assessment purposes.

19. A system comprising:
a processor for authorizing transaction requests;
a tangible, non-transitory memory configured to communicate with the processor;
the tangible, non-transitory memory having instructions stored thereon that, in response to execution by the processor, causes the processor to perform operations;
a financial institution form filling tool bar application in communication with the processor, wherein the financial institution form filling tool bar application is configured to receive log in information to access a financial institution system, wherein the log in information is transmitted via the financial institution form filling tool bar application to the financial institution system, wherein the log in information is remotely verified by the financial institution system;
the financial institution form filling tool bar application further configured to permit access to the financial institution form filling tool bar application, in response to the verification of the log in information;
the financial institution form filling tool bar application further configured to receive a user selection of a transaction account; and
the financial institution form filling tool bar application further configured to populate, in response to the user selection, transaction information into the merchant electronic form of a merchant website, wherein the transaction information is remotely stored by the financial institution system, wherein the remotely stored transaction information is transmitted from the financial institution system.

20. A system comprising:
a processor for authorizing transaction requests;
a tangible, non-transitory memory configured to communicate with the processor;
the tangible, non-transitory memory having instructions stored thereon that, in response to execution by the processor, causes the processor to perform operations;
a receiving module in communication with the processor, wherein the receiving module is configured to receive log in information to a financial institution system, wherein the log in information is transmitted via the processor to the financial institution system, wherein the log in information is remotely verified by the financial institution system;
an enabling module in communication with the processor, wherein the enabling module is configured to enable web browser integrated form filling, in response to the verification of the log in information;
the receiving module is further configured to receive a user selection of a transaction account;
a populating module in communication with the processor, wherein the populating module is configured to populate, in response to the user selection, transaction information into a merchant electronic form of the merchant website, wherein the transaction information is stored remotely by the financial institution system, wherein the transaction information comprises a dynamic security code received from the financial institution system, wherein the remotely stored transaction information is transmitted from the financial institution system; and
an enhanced authorization data module in communication with the processor, wherein the enhanced authorization data module is configured to enable passive collection of enhanced authorization data.
